(19) United States
(12) Patent Application Publication
(10) Pub. No.: US 2019/0099654 A1
(43) Pub. Date: Apr. 4, 2019

(54) FOLDABLE EXERCISE MAT

(71) Applicants: Derby Riccardo Sobalvarro, Burbank, CA (US); Ximena Anais Samaniego Palomino, Barcelona (ES)

(72) Inventors: Derby Riccardo Sobalvarro, Burbank, CA (US); Ximena Anais Samaniego Palomino, Barcelona (ES)

(21) Appl. No.: 15/721,873

(22) Filed: Sep. 30, 2017

(51) Int. Cl. A63B 71/06; A63B 21/00; H04R 1/02

(52) U.S. Cl. CPC A63B 71/0622; A63B 21/4037; H04R 1/028; A63B 2210/50; A63B 2209/00; H04R 2420/07; A63B 2225/09; A63B 2225/093; A63B 2071/0625; H04R 2201/028; A63B 2225/50

(57) ABSTRACT

The present invention is an improved version of a foldable exercise mat that can include the addition of a built-in speaker system with blue-tooth capability, which allows the user to fold the mat without obstruction in a compact and stackable way that current foldable mats are unable to do, and allows the user to connect their electronic devices to the built-in speakers via blue-tooth or auxiliary jack. The core components of the invention are mat tiles that can be made from a variety of materials, i.e. plastic, rubber, TPE, etc., and a mesh insert. As an option, the mat can include a blue-tooth media system with speakers, which, generally speaking, are configured as follows: the mat tiles are aligned and assembled onto the mesh insert using an adhesive or by other means, i.e. stitching, thermo-adhesion or molding the tiles directly around the mesh insert, creating a dual layer of cushion tiles above and below the mesh insert that forms a rectangular shape with either square or rounded corners. The media device can be inlaid to the mat tiles with speakers at the head and foot of the mat to not interfere with the mat's ability to fold compactly. The invention can be used generally for the practice of yoga, meditation, stretching or other exercises where the user would like to be separated from direct contact with the floor and provide themselves with a cushioned support on various surfaces. Furthermore, it should be noted that the gaps created by the alignment of the mat tiles on the mesh insert are purposefully done so in a way to allow for the mesh insert joining the tiles to fold freely and without obstruction, allowing for the mat tiles to stack in an organized, tight and compact arrangement that allows the user to travel and store the mat with ease.

### BACKGROUND OF THE INVENTION

### 1. Field of the Invention

The invention relates generally to Folding Exercise/Meditation/Yoga Mats

### 2. Background

Currently there are a number of solutions for foldable exercise mats. Some of these solutions attempt to fold into a compact and uniformly stacked shape, but fail to meet the needs of the industry because they are constructed in a way that makes it impossible for the mat to fold uniformly and compactly without obstruction from its own material. Other solutions attempt to provide thinner material to allow it to fold easier, but these solutions are similarly unable to meet the needs of the industry because the thinner material does not provide sufficient cushioning or comfort for the user, thereby forcing the user to carry and use additional material to support themselves with during use that defeats the purpose of having the mat. Designs of the mat that allow for thicker material are unable to fold. Still other solutions seek to roll the mat to accommodate the thicker material but these solutions also fail to meet industry needs, because they are bulky, difficult to transport and store, and are more difficult to keep clean. The aforementioned are also more difficult and slower to fold or roll.

It would be desirable to have an improved exercise mat that easily folds to be a compact, storable, transportable size. Furthermore, it would be desirable to have a mat with gaps in its construction in such a way that the mesh insert can fold freely without the obstruction of the material of the mat restricting themselves from creating a compact, uniform shape when folded. Even further, it would be desirable for the users to be able to fold the mat during use to provide themselves with extra cushion support when needed without the need for bringing extra equipment. Still further, it would be desirable to have a mat with the capacity for the user to connect an electronic device to a built-in speaker system via blue-tooth or auxiliary cable allowing the user to listen to content while using the mat without the use of headphones or relying on the speaker system of the electronic device. Therefore, there currently exists a need in the industry for an exercise mat that folds easily into a compact uniform shape so that it can be easily stored and transported better and that also has the capacity to connect with the users' electronic devices via blue-tooth or auxiliary jack to allow the user to listen to content while exercising, meditating, practicing yoga, or other activities where the user would like to be separated from direct contact with the floor and provide themselves with extra cushioning support on demand. The method in which the mat folds also serves to improve the speed in which the mat can be folded, and the hygiene, as folding the mat does not allow for the surface touching the floor to touch the surface in contact with the user.

### SUMMARY OF THE INVENTION

Disclosed is a foldable exercise mat, which is made up of the following components: material such as plastic, PVC, TPE, rubber, etc. created to form cushion tiles, a mesh insert and materials necessary to join the tiles to the mesh insert such as adhesive or use of other joining method, i.e. stitching, thermo-adhering processes, or molding the material directly around/on to the mesh insert. These components are connected as follows: the cushioned tiles are arranged and adhered to the mesh insert using an adhesive or other joining method mentioned above to create a dual-layered tile pattern above and below the mesh insert with gaps in between each tile formation allowing the exposure of the inner mesh insert on each side of the tiles that allows the mat to fold without obstruction.

The device may also have one or more of the following: 1.) Mat material that is open or closed cell to keep from absorbing liquid or sweat, biodegradable, environmentally safe (a.k.a. “eco”), i.e. TPE, jute, rubber, etc. 2.) A mesh insert of jute, plastic, cotton, or other pliable material, and 3.) An adhesive to join the tiles to the mesh insert that is natural, eco, or otherwise, or utilizing another method for joining the tiles to the mesh insert, i.e. stitching with thread, or thermo-adhering methods, or molding the tiles directly around the mesh insert. 4.) The cushioned tiles could also be inserted into a pocketed sheet serving as the mesh insert and closed to create an equal form that allows the mat to fold in similar fashion 5.) The cushioned tiles can be arranged on the mesh insert in a single layer to achieve the same folding ability and compact shape 6.) A speaker system may also be inserted to allow the user to connect an electronic device to the speakers via blue-tooth or auxiliary cable. The speaker system may also be rechargeable. The speakers may be in-laid into the mat to maintain the mat's ability to fold into a compact and uniform shape. 7.) A folding aid to assist in the closure of the mat via draw-string or other cable and 8.) A closing mechanism or latch to keep the mat from opening once it is in its folded state.

The disclosed device is unique when compared with other known devices and solutions because it provides: (1) the ability to fold the mat quickly and easily so that it compacts neatly and uniformly; (2) the ability to provide a thicker material for desired user comfort while maintaining the ability to fold tightly and compactly after or during use so that the users can provide themselves extra cushioning when needed without the use of external additional material during their practice (3) the ability for the users to align themselves with the grid lines created by the assembly of the cushion tiles on the mesh insert (4) the ability for the user to use the folded mat as a supported sitting device for things such as meditation and (5) the ability for the users to connect their electronic device to a built-in speaker system via blue-tooth or auxiliary jack during their practice that is assembled in such a way that still allows for the mat to fold evenly and compactly.

The disclosed device is unique in that it is structurally different from other known devices or solutions. More specifically, the device is unique due to the presence of: (1) an exposed mesh insert created by the technique of separating the cushioning material into tiles and arranging them above and below the insert in a way that creates gaps between the tiles on each side; (2) the gaps in between the cushion tiles proportional to material thickness created when the cushion tiles are attached to the mesh insert to allow the insert to fold without obstruction; and (3) the inlaid audio speaker system allowing users to connect their electronic device via blue-tooth or auxiliary jack while still being able to fold the mat into a compact and uniform shape.

Among other things, it is an object of the present invention to provide a foldable exercise mat that does not suffer from any of the problems or deficiencies associated with previous solutions.

It is still further an objective of the present invention to create a device that is more economical to produce, easier to manufacture, easier to repair and more durable.

Further still, it is an objective of the present invention to create a device that is smaller and more lightweight than other solutions, thereby enabling the device to be more easily portable.

The invention will now be described more fully hereinafter with reference to the accompanying drawings, which are intended to be read in conjunction with both this summary, the detailed description and any preferred and/or particular embodiments and variations specifically discussed or otherwise disclosed. This invention may, however, be embodied in many different forms and should not be construed as limited to the embodiments set forth herein; rather, these embodiments are provided by way of illustration only and so that this disclosure will be thorough, complete and fully conveys the full scope of the invention to those skilled in the art.

### BRIEF DESCRIPTION OF THE DRAWINGS

FIG. 1-A through FIG. 1-C Shows the unique tile assembly of cushions on the mesh insert of the foldable mat.

FIG. 2 Shows a zoomed in view of the unique tile assembly of cushions on the mesh insert to demonstrate the gaps created in between the tiles that allow for the mesh insert to fold without obstruction.

FIG. 3-A through FIG. 3-C Shows the top view, front view and side view of the completed assembly of the foldable mat.

FIG. 4 Shows the method of folding the mat along its vertical axis.

FIG. 5 shows a zoomed in view of the inner mesh of the mat folding freely without obstruction from the cushioning material.

FIG. 6-A through 6-C Shows the method of the mat folding along the horizontal axes to depict how the mat can be manipulated during use to provide extra cushioning for the user when needed.

FIG. 7 Shows a zoomed in few of the mat folded along its horizontal axis demonstrating how it sits evenly on the other tiles.

FIG. 8-A through FIG. 8-B Shows the method of how the mat is first folded along its longer vertical axis (as described in FIG. 4) and then its shorter horizontal axes to fold into a compact and uniform shape.

FIG. 9 Shows a speaker system inlaid within the tile cushions as an alternate version of the foldable mat.

FIG. 10 Shows a close up view of the inlaid speaker system to illustrate how it can be assembled in an alternate version of the mat.

### DETAILED DESCRIPTION OF THE INVENTION

The Present Invention is Directed to Unobstructed Folding Exercise/Meditation/Yoga Mats

In its most complete version the device is made up of the following components: cushioned tiles, a pliable mesh insert, adhesive, an audio speaker system, and a latch system to keep it closed in its folded state. These components are connected as follows: the cushioned tiles are spaced and aligned on the mesh insert creating a dual layer above and below the mesh insert of cushioned tiles in such a way that there are gaps in between the tiles sufficiently spaced to allow the inner mesh to fold without obstruction and that the cushion tiles will lay on one another uniformly and compactly when folded. The speakers and amplification system can be inserted at the head and/or the foot of the mat and are inlaid so that the mat can still fold and maintain its shape. It should further be noted that: depending on the thickness of the material used to create the cushioned tiles, the tiles are to be spaced proportionately so that the gaps are sufficiently wide enough to allow for the mesh insert to fold and the tiles to sit one on top of the other uniformly and compactly without obstruction. The speaker system can be connected to the users' electronic device via blue-tooth or auxiliary jack.

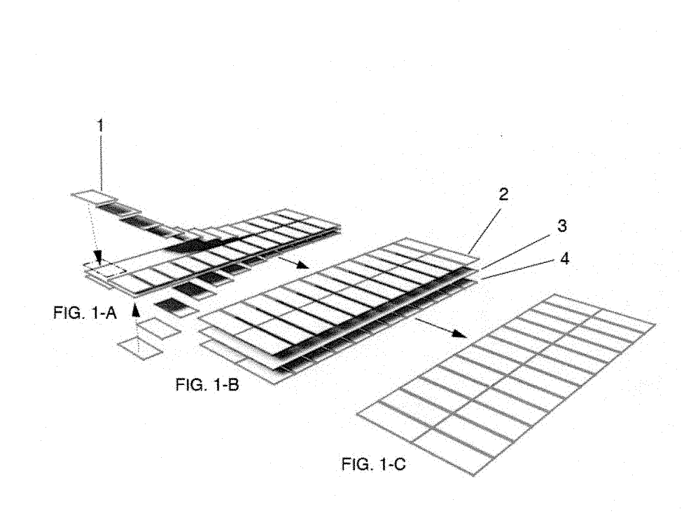

In FIG. 1-A through FIG. 1-C a diagram is shown illustrating the unique and improved assembly of the mat. In FIG. 1-A numeral 1 shows that the cushions are cut into equal sized tiles that are individually placed above (numeral 2 in FIG. 1-B) and below (numeral 4 in FIG. 1-B) a mesh insert (numeral 3 in FIG. 1-B). The tiles are then adhered to the mesh insert as is shown in FIG. 1-C. The tiles can be adhered to the mesh insert using adhesive, stitching or thermo-adhering methods, or molded directly around the mesh insert itself, bypassing the steps in FIG. 1-A and FIG. 1-B, and forming FIG. 1-C directly.

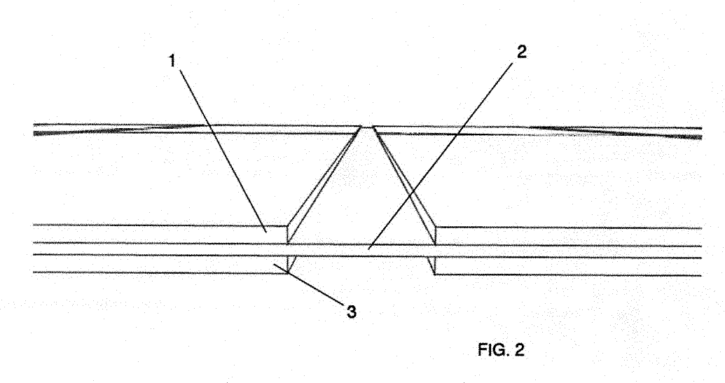

In FIG. 2 a diagram is shown illustrating a zoomed in view of the final assembly of the mat as described in FIG. 1-C. Here we can see how the tiles are situated in such a way to create a dual layer above (numeral 1) and below (numeral 3) an exposed mesh insert (numeral 2).

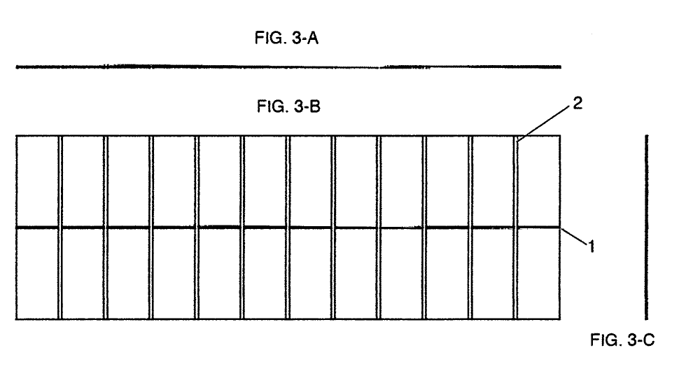

In FIG. 3-A through FIG. 3-C we show illustrations of the final assembly from the top (FIG. 3-B), side (FIG. 3-A) and front (FIG. 3-C) angles. In FIG. 3-B numeral 1 indicates the mat's long vertical axis and numeral 2 indicates the mat's shorter horizontal axes of which both can fold.

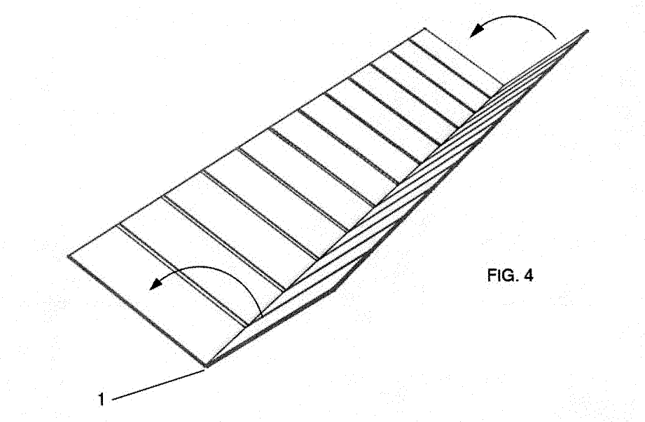

In FIG. 4 we show the method in which the mat folds along its vertical axis (numeral 1).

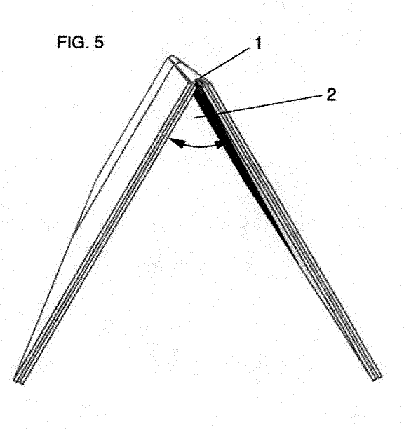

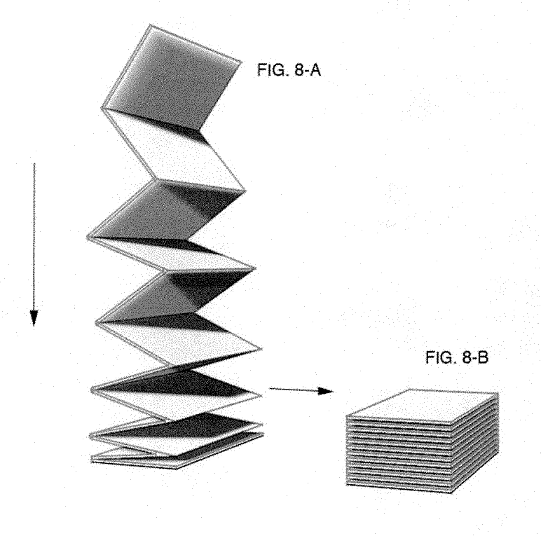

In FIG. 5 we show the folding function of the unique assembly of the cushion tiles on the mesh insert. Numeral 1 illustrating that the mesh insert is exposed to fold freely without obstruction from the cushion mat materials. We can also see from numeral 2 that the unique assembly creates room in between the mesh insert and the cushion tiles to allow for the cushion tiles to sit squarely together once the mat is folded (shown later in FIG. 8-B.)

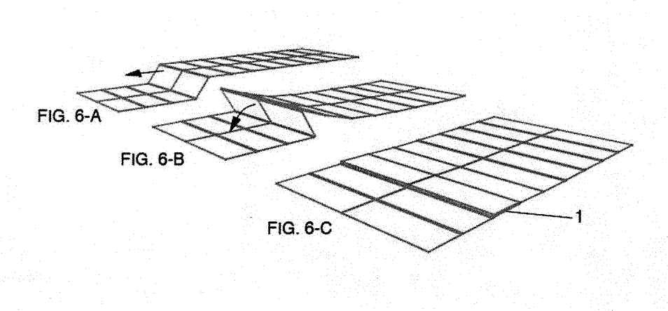

In FIG. 6-A through FIG. 6-C we show the method in which the mat is able to fold along its horizontal axes. FIG. 6-A indicates how one end of the mat can move while the other stays in place. FIG. 6-B shows how the horizontal axis folds to allow the mat to fold on itself and create an extra cushion as shown in FIG. 6-C numeral 1. The mat can be folded along its horizontal axes as many times as desired by the user to provide additional cushioning and still maintain its shape.

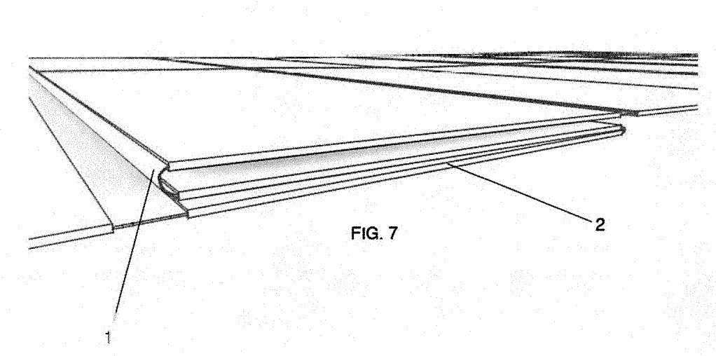

In FIG. 7 we have a zoomed in view of the folding action described in FIG. 6-A through FIG. 6-C in which numeral 1 indicates how the mesh insert folds to allow the cushion tiles to sit one on top of the other depicted in numeral 2 to increase the amount of cushion support the user desires.

In FIG. 8-A through FIG. 8-B we have an illustration in which FIG. 8-A shows the method in which the mat is folded along its vertical axis (as described in FIG. 4) and then its horizontal axes to fold the mat into its closed position as show in FIG. 8-B. The closed position in FIG. 8-B shows how all of the cushion tiles are able to sit uniformly one on top of the other to form a compact and uniform shape that enables it to be easily stored and transported, or used as a sitting device if desired.

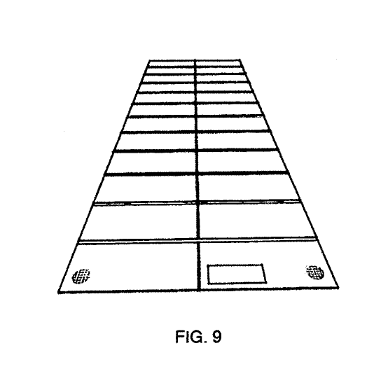

FIG. 9 shows an optional version of the mat in which there is a speaker system inlaid into the mat material. This detail, that the speaker system is inlaid into the mat, is key as it allows the mat to retain its ability to fold into its compact and uniform shape as described in FIG. 8-B.

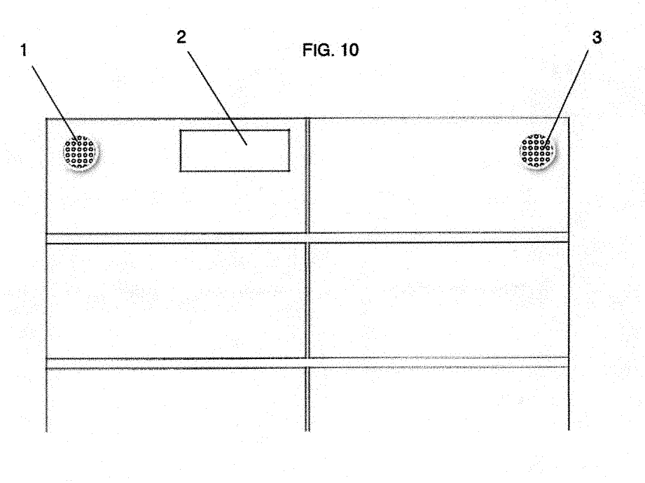

In FIG. 10 we have a closer view of the speaker system assembly as described in FIG. 9. Here numerals 1 and 2 show the possible positioning of the speaker assembly while numeral 3 indicates a possible positioning for the interface and amplification assembly that will power the speakers. All components are inlaid in the cushion tiles to maintain an even and flat surface allowing the mat to continue to fold in a uniform and compact way.

As discussed, the invention has many different features, variations and multiple different embodiments. The invention has been described in this application at times in terms of specific embodiments for illustrative purposes and without the intent to limit or suggest that the invention conceived is only one particular embodiment. It is to be understood that the invention is not limited to any single specific embodiments or enumerated variations. Many modifications, variations and other embodiments of the invention will come to mind of those skilled in the art to which this invention pertains, and which are intended to be and are covered by both this disclosure. It is indeed intended that the scope of the invention should be determined by proper interpretation and construction of the disclosure, including equivalents, as understood by those of skill in the art relying upon the complete disclosure at the time of filing.

1.- I claim this is a foldable exercise mat comprising: cushion tiles made of natural rubber or other variations of cushioning material; and a mesh insert, which is made up of a fabric or other pliable material; wherein said cushion tiles are arranged and attached to said mesh insert in a uniform manner using an adhesive, stitching and/or heat-transfer methods, that leaves gaps between said cushion tiles to expose said mesh insert in a way that said mat can fold freely into a uniform and compact closed position without obstruction from said cushion tiles, and unfold to lie flat and still provide the user with superior cushion support.

2.- if a speaker system, comprised of two speakers and an amplifier, is inlaid into the mat tiles the user can connect an external electronic device to the mat using an audio cable jack or blue-tooth wireless connection, to play audio from said external electronic device whilst using the mat, and because of said inlaid design, the mat will still fold freely without obstruction into a uniform and compact closed position.

1. Dependent upon claim 1, in the folded/closed position, the mat can be used as a seat for meditation or other activities where the user would prefer a raised seat height.

2.- Dependent upon claim 1, the user can fold the mat along its horizontal axes during use to give the user additional cushioning support when and where desired.

3.- Dependent upon claim 1, the arrangement of tiles over the exposed mesh insert creates a grid design in which users can align themselves during their practice.

4.- Dependent upon claim 1, folding the mat along the vertical axis and then the horizontal axes allows the user to close the mat in a unique and superior hygienic way, as the user's side of the mat never comes into contact with the side of the mat touching the ground.
